(19) United States
(12) Patent Application Publication
(10) Pub. No.: US 2023/0095266 A1
(43) Pub. Date: Mar. 30, 2023

(54) SERVER, SPECIFYING SYSTEM, SPECIFYING METHOD, AND STORAGE MEDIUM STORING SPECIFYING PROGRAM

(71) Applicant: NEC Corporation, Minato-ku, Tokyo (JP)

(72) Inventors: Satoshi KIMURA, Tokyo (JP); Daishi YUZAWA, Tokyo (JP)

(73) Assignee: NEC Corporation, Minato-ku, Tokyo (JP)

(21) Appl. No.: 17/908,638

(22) PCT Filed: Mar. 4, 2021
(86) PCT No.: PCT/JP2021/008396

§ 371 Date: Sep. 1, 2022

(30) Foreign Application Priority Data
Mar. 26, 2020 (JP) 2020-055545

(51) Int. Cl. G10L 15/183; G10L 15/22

(52) U.S. Cl. CPC G10L 15/183; G10L 15/22; G10L 2015/221; G10L 2015/223

(57) ABSTRACT

In order to specify, through a simple operation, members of an organization to which a user belongs, this server comprises: an extraction means which extracts an instruction on the basis of a voice input by the user belonging to the organization; a processing means which processes the instruction on the basis of the attributes of the user in the organization; and a specifying means which specifies at least one among a plurality of the members belonging to the organization on the basis of the processed instruction.

### TECHNICAL FIELD

The present invention relates to a server, a specifying system, a specifying method, and a storage medium storing a specifying program that are capable of specifying, by a simple operation, a member of an organization to which a user belongs.

### BACKGROUND ART

When a user operates a system, the user provides an instruction for the system via a user interface (UI). As one example, a user inputs a character or a voice to a UI, and thereby provides an instruction for a system.

PTL 1 discloses that a user inputs a voice via a UI provided in an in-vehicle device, and thereby operates a navigation system. PTLs 2 to 4 also disclose that a user operates, via a UI, various types of systems.

### CITATION LIST

### Patent Literature

[PTL 1] Japanese Unexamined Patent Application Publication No. 2014-106927

[PTL 2] Japanese Translation of PCT International Application No. 2018-537795

[PTL 3] European Patent Application Publication No. 3550939

### DESCRIPTION

[PTL 4] U.S. Patent Application Publication No. 2009/0150156

### DESCRIPTION

### Summary of Invention

### Technical Problem

From a point of view of usability, it is desirable for a system to be appropriately operated based on simple input from a user. However, in order to accurately operate a system in line with an intention of a user, the user needs to provide a detailed instruction for the system in some cases. It is assumed that, for example, a user intends to contact, by using a system capable of specifying contact information of an employee of a company for which the user him/herself works, an employee A in the same department as the user. In this case, in order not to erroneously contact an employee B having the same surname as the co-worker, the user needs to provide, for a system, not only a surname of the employee A but also a department to which the user him/herself belongs and the like. In this manner, when there are many pieces of required information, an amount of information to be input to a UI by a user increases, and as a result, an operation therefor is cumbersome.

The present invention has been made in view of the above-described problem, and an object of the present invention is to specify a member of an organization to which a user belongs, by a simple operation.

### Solution to Problem

A sever according to the present invention includes:

an extraction means that extracts an instruction, based on a voice being input from a user belonging to an organization;

a processing means that processes the instruction, based on an attribute of the user in the organization; and

a specifying means that specifies, based on the processed instruction, at least one of a plurality of members belonging to the organization.

Further, a specifying system according to the present invention includes:

a terminal that transmits a voice being input from a user belonging to an organization; and

a server including
an extraction means that extracts an instruction, based on the voice from the terminal,
a processing means that processes the instruction, based on an attribute of the user in the organization, and
a specifying means that specifies, based on the processed instruction, at least one of a plurality of members belonging to the organization.

Further, a specifying method according to the present invention includes:

extracting an instruction, based on a voice being input from a user belonging to an organization;

processing the instruction, based on an attribute of the user in the organization; and

specifying, based on the processed instruction, at least one of a plurality of members belonging to the organization.

Further, a storage medium according to the present invention stores a specifying program causing an information processing device to execute:

processing of extracting an instruction, based on a voice being input from a user belonging to an organization;

processing of processing the instruction, based on an attribute of the user in the organization; and

processing of specifying, based on the processed instruction, at least one of a plurality of members belonging to the organization.

### Advantageous Effects of Invention

According to the present invention, a member of an organization to which a user belongs can be specified by a simple operation.

### BRIEF DESCRIPTION OF DRAWINGS

FIG. 1 is a block diagram illustrating a configuration example of a specifying system according to a first example embodiment of the present invention.

FIG. 2 is a flowchart illustrating an operation example of the specifying system according to the first example embodiment of the present invention.

FIG. 3 is a block diagram illustrating a modified example of the specifying system according to the first example embodiment of the present invention.

FIG. 4 is a block diagram illustrating a configuration example of a server according to a second example embodiment of the present invention.

FIG. 5 is a flowchart illustrating an operation example of the server according to the second example embodiment of the present invention.

FIG. 6 is a block diagram illustrating a configuration example of a specifying system according to a third example embodiment of the present invention.

FIG. 7 is a flowchart illustrating an operation example of the specifying system according to the third example embodiment of the present invention.

### EXAMPLE EMBODIMENT

### First Example Embodiment

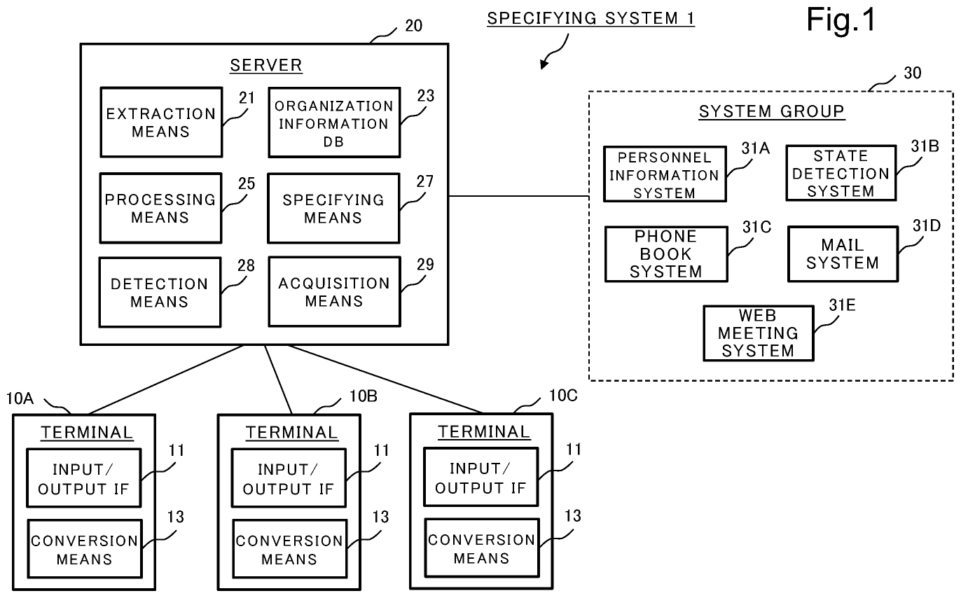

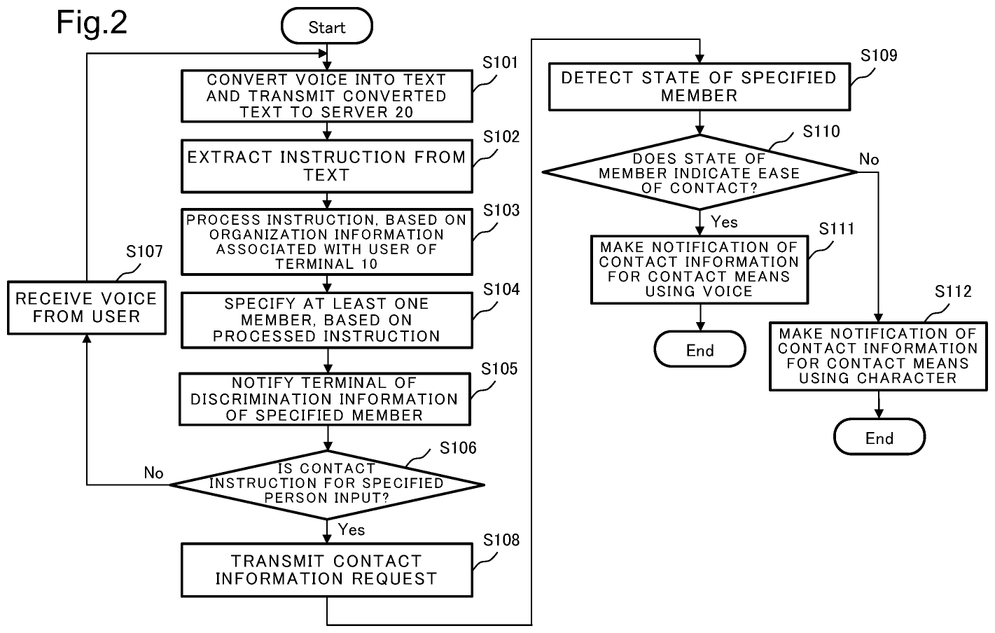

A specifying system 1 according to a first example embodiment is described based on FIGS. 1 and 2. FIG. 1 is a block diagram illustrating a configuration example of the specifying system 1. FIG. 2 is a flowchart illustrating an operation example of the specifying system 1.

A configuration of the specifying system 1 is described. As illustrated in FIG. 1, the specifying system 1 includes a terminal 10A, a terminal 10B, a terminal 10C, a server 20, and a system group 30. In the following description, when the terminal 10A, the terminal 10B, and the terminal 10C do not need to be discriminated from each other, each of the terminal 10A, the terminal 10B, and the terminal 10C is referred to as a terminal 10.

The terminal 10 is described. It is assumed that the terminal 10 is allocated to each of members belonging to a specific organization. The terminal 10 includes an input/output interface (IF) 11 and a conversion means 13. The input/output IF 11 receives input from a user of the terminal 10. The input/output IF 11 receives, for example, a voice uttered by a user. The conversion means 13 converts input received by the input/output IF 11 into a predetermined format. The conversion means 13 converts, for example, a voice received by the input/output IF from a user into a text.

The terminal 10 transmits data converted by the conversion means 13 to the server 20. The terminal 10 stores, in a memory (not illustrated), owner information of the terminal 10. The terminal 10A stores, for example, a user A as an owner. The terminal 10 is, for example, a mobile phone, a smartphone, or a wearable terminal.

The server 20 is described. The server 20 includes an extraction means 21, an organization information database (DB) 23, a processing means 25, a specifying means 27, a detection means 28, and an acquisition means 29. The server 20 is configured to be communicable with the terminal 10 and the system group 30.

The extraction means 21 is described. The extraction means 21 includes a memory (not illustrated) for storing a character allocated to a classification referred to as a “parameter” or a “command”. The extraction means 21 extracts an instruction, based on a voice input from a user belonging to an organization. Specifically, the above description is as described below. The extraction means 21 receives, from the terminal 10, a text converted from a voice input to the terminal 10. The extraction means 21 extracts, from the received text, as an instruction, a portion matched with a character stored in the memory, together with a classification allocated to the character.

It is assumed that, for example, in a memory (not illustrated) of the extraction means 21, characters of “Tanaka” allocated to a classification of a “parameter” and characters of “phone” allocated to a classification of a “command” are stored. In this example, when the server 20 receives, from the terminal 10, a text “I want to make a phone call to Mr./Ms. Tanaka”, the extraction means 21 extracts characters of “Tanaka” as a “parameter” and also extracts characters of “phone” as a “command”. In this case, an instruction is a combination of a “parameter” and a “command”. An instruction includes, as in the above-described “parameter”, a first keyword capable of specifying each of members of an organization. The first keyword is used, for example, when the specifying means 27 specifies a member in an organization from a personnel information system 31 to be described later. The instruction includes, as in the above-described “command”, a second keyword indicating a contact means with respect to a specified member. The second keyword is used when the acquisition means 29 acquires contact information of a specified member from any one of systems included in a system group 30 to be described later. The acquisition means 29 selects, for example, a system relevant to a contact means indicated by the second keyword from among systems included in the system group 30 to be described later. The acquisition means 29 acquires contact information of a member specified from the selected system.

The organization information DB 23 is described. The organization information DB 23 stores an attribute in an organization of a user of the terminal 10. The attribute is specifically at least one of a department to which a user belongs, a team to which a user belongs, or a project engaged in by a user. The attribute may be a combination of at least two of the above-described department, team, and project. The organization information DB 23 in the specifying system 1 stores, for example, a fact that a user A of the terminal 10A belongs to an accounting department and is engaged in a project A.

The processing means 25 is described. The processing means 25 processes, based on an attribute of a user in an organization, an instruction extracted by the extraction means 21. Specifically, when the extraction means 21 extracts an instruction from a text output by the terminal 10A, the processing means 25 acquires, from the organization information DB 23, an attribute in an organization of a user A who is the owner of the terminal 10A. The processing means 25 adds the acquired attribute to the extracted instruction.

When, for example, in the extraction means 21, characters of “Tanaka” are extracted as a “parameter”, the processing means 25 processes the “parameter”, based on an attribute of an “accounting department” to which a user A belongs and generates a parameter of a “Tanaka of the accounting department”.

The specifying means 27 is described. The specifying means 27 is able to refer to the personnel information system 31A in the system group 30. In the personnel information system 31A, a full name of a member, a department to which a member belongs in an organization, a team in which a member participates, a project in which a member is engaged, and a unique number (an employee number or the like) allocated to a member are registered as discrimination information. The specifying means 27 specifies, based on a processed instruction, at least one of a plurality of members belonging to an organization. Specifically, the specifying means 27 retrieves, according to a parameter in a processed instruction, information in the personnel information system 31A and thereby, specifies a member. The specifying means 27 notifies the terminal 10 of discrimination information of the specified member.

When in the processing means 25, for example, a processed parameter of a “Tanaka of accounting department” is generated, the specifying means 27 specifies employees belonging to the accounting department and including “Tanaka” in their name, from among employees registered in the personnel information system 31A. At that time, the specifying means 27 notifies the terminal 10 of a full name of a specified employee and a name of a department to which the specified employee is assigned.

The terminal 10 displays, when notification of discrimination information of a specified member is made from the server 20, the notified discrimination information and inquires of a user whether to contact the specified member. The terminal 10 transmits, when a contact instruction indicating that it is desired to contact the specified member is input from the user, a contact information request to the server 20.

The detection means 28 is described. The detection means 28 is communicable with a state detection system 31B in the system group 30. The state detection system 31B is a system capable of detecting a schedule or a presence state of a member. The detection means 28 detects, when the server 20 receives a contact information request from the terminal 10, a state of each of members of an organization. Specifically, the detection means 28 communicates with the state detection system 31B and thereby detects whether contacting a member specified by the specifying means 27 is allowed or contacting the member is not allowed. In this case, a presence state of a member may be, for example, a state such as “contactable” and the like in a management system of group members or a communication tool such as an instant messenger.

The state detection system 31B is, for example, a schedule management system in which schedules of members are input. In this case, the detection means 28 acquires, from the state detection system 31B, a schedule of a member at a time when the server 20 receives a contact information request. The detection means 28 determines, when a schedule is open, that contacting a member is allowed. The detection means 28 determines, when a schedule is not open, that contacting a member is not allowed. In this case, a presence state of a member may be, for example, a state such as “unable to respond”, “uncontactable”, “busy”, and the like in a management system of group members or a communication tool such as an instant messenger.

The acquisition means 29 is described. The acquisition means 29 is communicable with a phone book system 31C and a mail system 31D in the system group 30. In the phone book system 31C, contact information (a phone number or the like) of a contact means using a voice is registered with respect to each member in an organization. In the mail system 31D, contact information (a mail address or the like) of a contact means using a character is registered with respect to each member in an organization.

In a web meeting system 31E, account information with respect to each member in a web meeting service is registered. The acquisition means 29 acquires contact information of a member specified by the specifying means 27 and transmits the acquired contact information to the terminal 10.

Specifically, when the detection means 28 detects that contacting a specified member is allowed, the acquisition means 29 refers to the phone book system 31C, acquires contact information of a contact means using a voice of the specified member, and notifies the terminal 10 of the acquired contact information. Meanwhile, when the detection means 28 detects that contacting a specified member is not allowed, the acquisition means 29 refers to the mail system 31D, acquires contact information of a contact means using characters of the specified member, and notifies the terminal 10 of the acquired contact information.

As described above, the configuration of the specifying system 1 has been described. Next, by using FIG. 2, a first operation example of the specifying system 1 is described. Note that, it is assumed that at a time of starting the present operation example, the server 20 communicates with a terminal 10A and thereby, discriminates that an owner of the terminal 10A is a user A belonging to an accounting department. In a memory (not illustrated) of the extraction means 21, it is assumed that characters of “Tanaka” allocated to a classification of a “parameter” and characters of “phone” allocated to a classification of a “command” are registered. Further, it is assumed that the input/output IF 11 of the terminal 10 receives a voice indicating that “I want to make a phone call to Mr./Ms. Tanaka” from the user A.

The terminal 10A converts, by using the conversion means 13, a voice received by the input/output IF 11 into a text and outputs the text to the server 20 (S101). According to this operation example, the terminal 10A outputs, to the server 20, a text “I want to make a phone call to Mr./Ms. Tanaka”.

The extraction means 21 of the server 20 extracts an instruction from the output text (S102). According to this operation example, the extraction means 21 extracts, from the text “I want to make a phone call to Mr./Ms. Tanaka”, an instruction of a “Tanaka” and a “phone”. The extraction means 21 classifies a “Tanaka” as a parameter and extracts a “phone” as a command.

The processing means 25 processes the instruction extracted by the extraction means 21, based on an attribute of a user of the terminal 10 in an organization (S103). According to this operation example, the processing means 25 refers to the organization information DB 23 and thereby, acquires, as attribute, an accounting department to which the user A belongs. The processing means 25 processes the parameter “Tanaka” extracted by the extraction means 21 into a “Tanaka of accounting department”.

The specifying means 27 specifies at least one member, based on the processed instruction (S104). According to this operation example, the specifying means 27 accesses the personnel information system 31A. The specifying means 27 specifies, according to a parameter of a “Tanaka of accounting department”, a person in which a “Tanaka” is included in his/her name and a department to which he/she belongs is an “accounting department” from among members of an organization registered in the personnel information system 31A.

The specifying means 27 further notifies the terminal 10A of discrimination information of the specified member (S105). According to this operation example, the specifying means 27 acquires, from the personnel information system 31A, a full name of the specified member being a “Tanaka of accounting department” and a name of a department to which the specified member is assigned and notifies the terminal 10A of the acquired information as discrimination information. Thereby, in the terminal 10A, a full name of the specified member and a name of a department to which the specified member is assigned are displayed. Alternatively, in the terminal 10A, the conversion means 13 converts a text into a voice and thereby, discrimination information of the specified member is output by voice to the user A. The terminal 10A receives, from the user A, a contact instruction for the specified member via the input/output IF 11.

The terminal 10 determines whether a contact instruction for the specified member is input (S106). When a predetermined time elapses without input of a contact instruction (No in S106), the terminal 10 determines that the specified member is not a person intended by a user of the terminal 10 and again, receives a voice from the user (S107). In the processing of S106, the terminal 10 may receive a rejection of a contact instruction. In this case, the terminal 10 determines, when receiving a rejection of a contact instruction, that the specified member is not a person intended by the user of the terminal 10 and again, may receive a voice from the user.

When a contact instruction is input within a predetermined time (Yes in S106), the terminal 10 transmits a contact information request to the server 20 (S108).

When the server 20 receives the contact information request, the detection means 28 of the server 20 detects a state of a member specified by the specifying means 27 (S109). According to the first operation example, the detection means 28 refers to the state detection system 31B and acquires a schedule of a “Tanaka of accounting department”.

The detection means 28 determines whether contacting an acquired member is allowed (S110). According to the first operation example, the detection means 28 determines that when a schedule of a “Tanaka of accounting department” is open, contact is allowed. The detection means 28 determines that when a schedule of a “Tanaka of accounting department” is not open, contact is not allowed.

When contacting a state of the acquired member is allowed (Yes in S110), the acquisition means 29 notifies, according to a command included in an instruction, the terminal 10A of contact information of a contact means using a voice of a specified member (S111). According to this operation example, the acquisition means 29 refers to the phone book system 31C according to a command of a “phone” included in an instruction and notifies the terminal 10A of a phone number of a “Tanaka of accounting department”.

When contacting the acquired member is not allowed (No in S110), the acquisition means 29 notifies the terminal 10A of contact information of a contact means using a text of the specified member (S112). Specifically, according to this operation example, the acquisition means 29 refers to the mail system 31D and notifies the terminal 10A of a mail address of a “Tanaka of accounting department”. As described above, the first operation example of the specifying system 1 has been described.

Next, by using FIG. 2 again, a second operation example of the specifying system 1 is described. It is assumed that at a time of starting the present operation example, the server 20 communicates with the terminal 10B and thereby discriminates a user B of the terminal 10B as a member of a team B. It is assumed that in a memory (not illustrated) of the extraction means 21, characters of “team” allocated to a classification of a “parameter” and characters of “web meeting” allocated to a classification of a “command” are registered. Further, it is assumed that an input/output IF 11 of the terminal 10B receives, from the user B, a voice indicating that “I want to hold a web meeting with team members”.

The terminal 10B converts, by the conversion means 13, a voice received from the input/output IF 11 into a text and outputs the text to the server 20 (S101). According to the second operation example, the terminal 10B outputs, to the server 20, a text “I want to hold a web meeting with team members”.

The extraction means 21 of the server 20 extracts an instruction from the output text (S102). According to this operation example, the extraction means 21 extracts, from a text “I want to hold a web meeting with team members”, an instruction of a “team” and a “web meeting”. The extraction means 21 classifies the “team” as a parameter and extracts the “web meeting” as a command.

The processing means 25 processes, based on an attribute of a user of the terminal 10 in an organization, the instruction extracted by the extraction means 21 (S103). According to this operation example, the processing means 25 refers to the organization information DB 23 and thereby, acquires, as an attribute, a team B to which the user B belongs. The processing means 25 processes the parameter “team” extracted by the extraction means 21 into the “team B”.

The specifying means 27 specifies, based on the processed instruction, at least one member (S104). According to this operation example, the specifying means 27 accesses the personnel information system 31A. The specifying means 27 specifies, according to a parameter of a “team B”, a person belonging to the “team B” from among members of an organization registered in the personnel information system 31A.

The specifying means 27 further notifies the terminal 10B of discrimination information of the specified member (S105). According to this operation example, the specifying means 27 acquires, from the personnel information system 31A, a name of a person belonging to a team B and a team name and notifies the terminal 10B of the name of the person belonging to the team B and the team name as discrimination information. Thereby, in the terminal 10B, the name of the person belonging to the team B and the name team B are displayed. Alternatively, in the terminal 10B, the conversion means 13 converts a text into a voice and thereby, a name of a member belonging to a team B and a name of the team B are output by voice. The terminal 10B receives, via the input/output IF 11, a contact instruction for a specified member from the user B.

The terminal 10 determines whether the contact instruction for the specified member is input (S106). When a predetermined time elapses without input of the contact instruction (No in S106), the terminal 10 determines that the specified member is not a person intended by a user of the terminal 10 and again, receives a voice from the user (S107). In the processing of S106, the terminal 10 may receive a rejection of a contact instruction. In this case, the terminal 10 determines, when receiving a rejection of a contact instruction, that the specified member is not a person intended by a user of the terminal 10 and again, receives a voice from the user.

When a contact instruction is input within a predetermined time (Yes in S106), the terminal 10 transmits a contact information request to the server 20 (S108).

When the server 20 receives a contact information request, the detection means 28 of the server 20 detects a state of the member specified by the specifying means 27 (S109). According to the second operation example, the detection means 28 refers to the state detection system 31B and acquires a schedule of a member belonging to the team B.

The detection means 28 determines whether contacting the acquired member is allowed (S110). According to the second operation example, the detection means 28 determines, when a schedule of each member belonging to the team B is open, that contacting the member is allowed. The detection means 28 determines, when a schedule of each member belonging to the team B is not open, that contacting the member is not allowed.

When contacting the acquired member is allowed (Yes in S110), the acquisition means 29 notifies the terminal 10 of contact information of a contact means using a voice of the specified member (S111). According to the second operation example, the acquisition means 29 notifies the terminal 10 of a uniform resource locator (URL) used for inviting a specified member to a web meeting according to a command of a “web meeting” included in an instruction. In the processing of S111, the acquisition means 29 may output, without notification to the terminal 10, an invitation instruction for a specified member to the web meeting system 31E. In this case, the web meeting system 31E invites the specified member to a web meeting.

When contacting the acquired member is not allowed (No in S110), the acquisition means 29 notifies the terminal 10 of contact information of a contact means using a text of the specified member (S112). According to the second operation example, the acquisition means 29 notifies, according to with a command of a “web meeting” included in an instruction, the terminal 10 of a URL used for notifying a specified member that the member is invited to a web meeting. In the processing of S112, the acquisition means 29 may output, without notification to the terminal 10, a notification instruction for a specified member to the web meeting system 31E. In this case, the web meeting system 31E notifies a specified member that the member is invited to a web meeting. As described above, the second operation example of the specifying system 1 has been described.

As described above, the server 20 according to the specifying system 1 includes an extraction means 21, a processing means 25, and a specifying means 27. The extraction means 21 extracts an instruction, based on a voice input by a user belonging to an organization. The processing means 25 processes the instruction, based on an attribute of the user in the organization. The specifying means 27 specifies, based on the processed instruction, at least one of a plurality of members belonging to the organization.

As described above, the server 20 processes, by using the above-described configuration, an instruction of a user, based on an attribute in an organization of the user and therefore, is able to specify, even when an instruction from a user is simple, a member of an organization to which the user belongs. As described above, the server 20 is able to specify, by a simple operation, a member of an organization to which a user belongs.

The specifying means 27 specifies, from among a plurality of members of an organization, a member whose attribute in the organization is common to the user. Thereby, the server 20 is able to specify, from among members of an organization to which a user belongs, a member with an attribute common to the user, by a simple operation.

An attribute according to the specifying means 27 is a department, a team, or a project in an organization. Thereby, the server 20 is able to specify, from among members of an organization to which a user belongs, members in a common department, a team, or a project, by a simple operation.

The specifying means 27 notifies the terminal 10 of discrimination information of a specified member. Thereby, a user of the terminal 10 can confirm a member specified by the server 20.

The server 20 further includes an acquisition means 29 capable of acquiring contact information from another system that stores contact information of members of an organization. The acquisition means 29 transmits, in response to reception, from the terminal 10, of a contact information request for requesting contact information of a member according to notified discrimination information, contact information of a specified member. Thereby, a user of the terminal 10 is able to simply contact a member specified by the server 20.

The server 20 further includes a detection means 28 that detects a state of each of a plurality of members. The acquisition means 29 transmits, to the terminal 10, contact information of a member according to a detection result of a state in each of specified members. Thereby, the server 20 is able to transmit, to the terminal 10, appropriate contact information according to a state (e.g., a schedule) of a specified member.

The acquisition means 29 transmits, to the terminal 10, when contacting a specified member is allowed, contact information of a contact means using a voice. The contact information of a contact means using a voice is, for example, a phone number or a URL used for activating communication software. Thereby, a user of the terminal 10 can simply call, when contacting a specified member is allowed, the specified member.

The acquisition means 29 transmits, to the terminal 10, when contacting a specified member is not allowed, contact information of a contact means using a character. The contact information of a contact means using a character is, for example, a mail address or a URL used for activating messenger chat software. Thereby, a user of the terminal 10 can contact the specified member, based on a character, while reducing a call when contacting a specified member is not allowed. As described above, the specifying system 1 has been described.

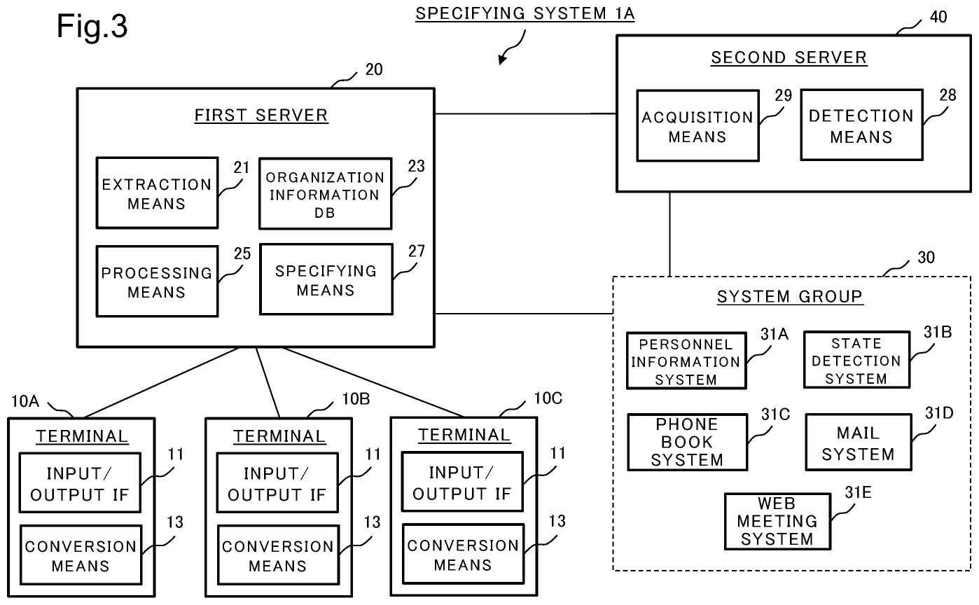

Next, by using FIG. 3, a specifying system 1A is described. The specifying system 1A is a modified example of the specifying system 1. The specifying system 1A is different from the specifying system 1 in that a first server 20 and a second server 40 communicable with a system group 30 are further included. In the specifying system 1A, a detection means 28 and an acquisition means 29 are included in the second server 40. An operation of the specifying system 1A is similar to the operation of the specifying system 1 illustrated in FIG. 2. The server 20 of the specifying system 1A including such a configuration may also specify, similarly to the server 20 of the specifying system 1, a member of an organization to which a user belongs, by a simple operation.

### Second Example Embodiment

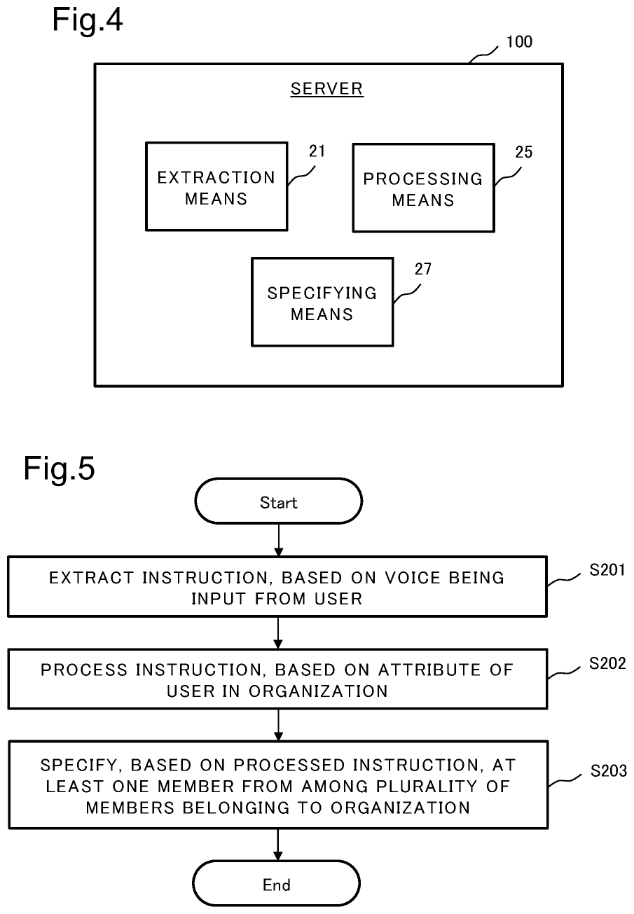

A server 100 according to a second example embodiment is described based on FIGS. 4 and 5. As illustrated in FIG. 4, the server 100 includes an extraction means 21, a processing means 25, and a specifying means 27. The extraction means 21 extracts an instruction, based on a voice input from a user belonging to an organization. The processing means 25 processes the instruction, based on an attribute of the user in the organization. The specifying means 27 specifies, based on the processed instruction, at least one of a plurality of members belonging to the organization.

Next, by using FIG. 5, an operation example of the server 100 is described.

The extraction means 21 extracts an instruction, based on a voice input from a user belonging to an organization (S201). Then, the server 100 receives, for example, via a communication terminal (not illustrated), a voice indicating that “I want to call Mr./Ms. Tanaka” from a user. The server 100 extracts, for example, by using a known voice recognition technique, an instruction of a “Tanaka” and a “phone” from the voice.

The processing means 25 processes the instruction, based on an attribute of the user in the organization (S202). The server 100 stores in advance, for example, an attribute (e.g., a department, a team, or a project) in an organization of a user being a caller of a voice and adds the attribute to an instruction. When an instruction of a “Tanaka” and a “phone” is extracted in the processing of S201, an “accounting department” being an attribute of a user is added to the “Tanaka”.

The specifying means 27 specifies, based on the processed instruction, at least one member (S203). The server 100 stores in advance, for example, information (e.g., the above-described attribute) relating to a plurality of members belonging to an organization of a user being a caller of a voice. In the processing of S203, the specifying means 27 specifies, for example, a member having the same attribute as an attribute included in a processed instruction. In this example, the specifying means 27 specifies a person including a “Tanaka” in his/her name from among members belonging to an accounting department of an organization. As described above, an operation example of the server 100 has been described.

As described above, the server 100 includes the extraction means 21, the processing means 25, and the specifying means 27. The extraction means 21 extracts an instruction, based on a voice input from a user belonging to an organization. The processing means 25 processes the instruction, based on an attribute of the user in the organization.

The specifying means 27 specifies, based on the processed instruction, at least one of a plurality of members belonging to the organization.

As described above, the server 100 processes, by using the above-described configuration, an instruction of a user, based on an attribute in an organization of the user and therefore, is able to specify, even when an instruction from a user is simple, a member of an organization to which the user belongs. Therefore, the server 100 is able to specify, by a simple operation, a member of an organization to which a user belongs.

### Third Example Embodiment

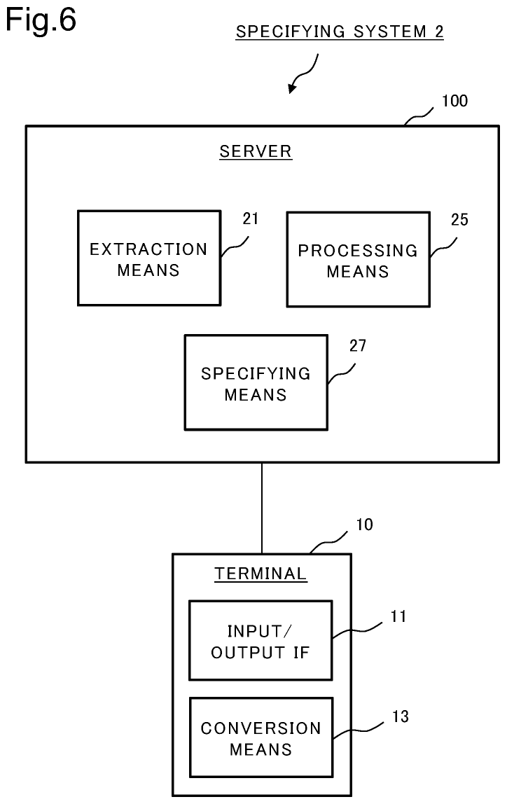

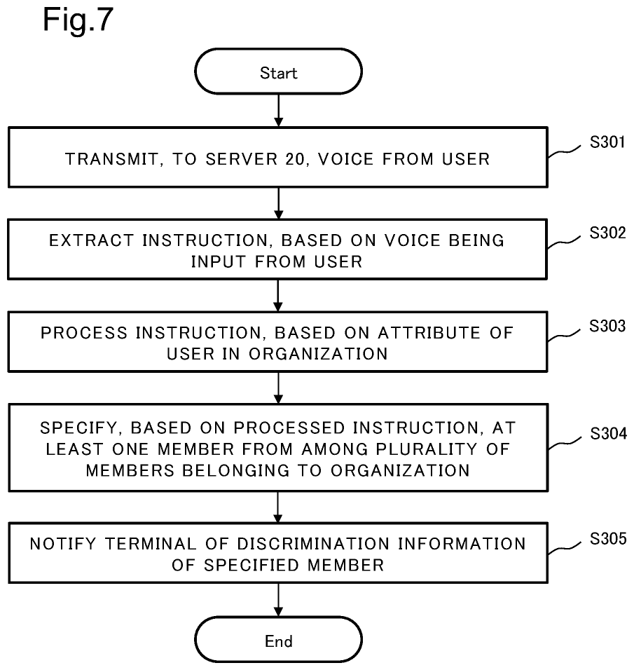

A specifying system 2 according to a third example embodiment is described based on FIGS. 6 and 7. As illustrated in FIG. 6, the specifying system 2 includes a server 100 and a terminal 10. The server 100 includes a function similar to the server 100 according to the second example embodiment. The terminal 10 includes a function similar to the terminal 10 included in the specifying system 1 according to the first example embodiment.

Next, by using FIG. 7, an operation example of the specifying system 2 is described.

The terminal 10 transmits a voice from a user to the server 20 (S301). The terminal 10 transmits, to the server 10, for example, a voice indicating that “I want to call Mr./Ms. Tanaka” from a user.

An extraction means 21 extracts an instruction, based on a voice input from a user belonging to an organization (S302). The server 100 extracts an instruction from a voice, for example, by using a known voice recognition technique. The server 100 extracts, for example, from a voice indicating that “I want to call Mr./Ms. Tanaka”, an instruction of a “Tanaka” and a “phone”.

A processing means 25 processes the instruction, based on an attribute of the user in the organization (S303). When an instruction of a “Tanaka” and a “phone” is extracted in the processing of S302, an “accounting department” being an attribute of a user is added to the “Tanaka”. The server 100 stores in advance, for example, an attribute (e.g., a department, a team, or a project) in an organization of a user of the terminal 10 being a caller of a voice and adds the attribute to an instruction.

A specifying means 27 specifies, based on the processed instruction, at least one member (S304). The server 100 stores in advance, for example, information (e.g., the above-described attribute) relating to a plurality of members belonging to an organization of a user of the terminal 10. In the processing of S304, the specifying means 27 specifies, for example, a member having the same attribute as an attribute included in a processed instruction. In this example, the specifying means 27 specifies a person including a “Tanaka” in his/her name from among members belonging to an accounting department of an organization.

The specifying means 27 further notifies a terminal 10A of discrimination information of the specified member (S305). It is assumed that discrimination information of a member is stored in advance in the server 100.

As described above, the server 100 includes the extraction means 21, the processing means 25, and the specifying means 27. The extraction means 21 extracts an instruction, based on a voice input from a user belonging to an organization. The processing means 25 processes the instruction, based on an attribute of the user in the organization. The specifying means 27 specifies, based on the processed instruction, at least one of a plurality of members belonging to the organization.

As described above, the server 100 processes, by using the above-described configuration, an instruction of a user, based on an attribute in an organization of the user and therefore, is able to specify, even when an instruction of a user is simple, a member of an organization to which the user belongs. As described above, the server 100 is able to specify, by a simple operation, a member of an organization to which a user belongs.

The whole or part of the example embodiments disclosed above can be described as, but not limited to, the following supplementary notes.

(Supplementary note 1)

A sever including:

an extraction means that extracts an instruction, based on a voice being input from a user belonging to an organization;

a processing means that processes the instruction, based on an attribute of the user in the organization; and

a specifying means that specifies, based on the processed instruction, at least one of a plurality of members belonging to the organization.

### (Supplementary Note 2)

The server according to supplementary note 1, wherein the specifying means specifies, from among the plurality of members, a member whose attribute in the organization is common to the user.

### (Supplementary Note 3)

The server according to supplementary note 1 or 2, wherein

the attribute is a department, a team, or a project in the organization.

### (Supplementary Note 4)

The server according to any one of supplementary notes 1 to 3, wherein the specifying means notifies a terminal of discrimination information of the specified member.

### (Supplementary Note 5)

The server according to supplementary note 4 further including

an acquisition means capable of acquiring contact information of a member of the organization, from another server that stores the contact information, wherein

the acquisition means transmits, to the terminal, contact information of the specified member in response to reception, from the terminal, of a contact information request for requesting contact information of the member according to the notified discrimination information.

(Supplementary note 6)

The server according to supplementary note 5 further including

a detection means that detects a state of each of a plurality of the members, wherein

the acquisition means transmits, to the terminal, contact information of the member according to a detection result of the state with respect to each of the specified member.

(Supplementary note 7)

The server according to supplementary note 6, wherein, when contacting the specified member is allowed, the acquisition means transmits, to the terminal, contact information of a contact means using a voice.

(Supplementary note 8)

The server according to supplementary note 6 or 7, wherein, when contacting the specified member is not allowed, the server transmits, to the terminal, contact information of a contact means using a character.

(Supplementary note 9)

The server according to any one of supplementary notes 1 to 8, wherein the extraction means extracts, as the instruction, a parameter indicating a member in the organization from the voice.

(Supplementary note 10)

The server according to any one of supplementary notes 1 to 9, wherein the processing means processes the instruction by adding an attribute of the user to the instruction.

### (Supplementary Note 11)

A specifying system including:

a terminal that transmits a voice being input from a user belonging to an organization; and

a server including
an extraction means that extracts an instruction, based on the voice from the terminal,
a processing means that processes the instruction, based on an attribute of the user in the organization, and
a specifying means that specifies, based on the processed instruction, at least one of a plurality of members belonging to the organization.

### (Supplementary Note 12)

A specifying method including:

extracting an instruction, based on a voice being input from a user belonging to an organization;

processing the instruction, based on an attribute of the user in the organization; and

specifying, based on the processed instruction, at least one of a plurality of members belonging to the organization.

### (Supplementary Note 13)

A storage medium storing a specifying program causing an information processing device to execute:

processing of extracting an instruction, based on a voice being input from a user belonging to an organization;

processing of processing the instruction, based on an attribute of the user in the organization; and

processing of specifying, based on the processed instruction, at least one of a plurality of members belonging to the organization.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-055545, filed on Mar. 26, 2020, the disclosure of which is incorporated herein in its entirety by reference.

### REFERENCE SIGNS LIST

1, 2 Specifying system
10, 10A, 10B, 10C Terminal
11 Input/output IF
13 Conversion means
20 Server, first server
21 Extraction means
23 Organization information DB
25 Processing means
27 Specifying means
28 Detection means
29 Acquisition means
30 System group
31A Personnel information system
31B State detection system
31C Phone book system
31D Mail system
31E Web meeting system
100 Server

What is claimed is:

1. A sever comprising:
an extractor configured to extract instruction, based on a voice being input from a user belonging to an organization;
a processor configured to process the instruction, based on an attribute of the user in the organization; and
a specifier configured to specify, based on the processed instruction, at least one of a plurality of members belonging to the organization.

2. The server according to claim 1, wherein
the specifier specifies, from among the plurality of members, a member whose attribute in the organization is common to the user.

3. The server according to claim 1 wherein
the attribute is a department, a team, or a project in the organization.

4. The server according to claim 1, wherein the specifier notifies a terminal of discrimination information of the specified member.

5. The server according to claim 4 further comprising
an acquisitor configured to being capable of acquiring contact information of a member of the organization, from another server that stores the contact information, wherein
the acquisitor transmits, to the terminal, contact information of the specified member in response to reception, from the terminal, of a contact information request for requesting contact information of the member according to the notified discrimination information.

6. The server according to claim 5 further comprising
a detector configured to detect a state of each of a plurality of the members, wherein
the acquisitor transmits, to the terminal, contact information of the member according to a detection result of the state with respect to each of the specified member.

7. The server according to claim 6, wherein, when contacting the specified member is allowed, the acquisitor transmits, to the terminal, contact information of a contactor using a voice.

8. The server according to claim 6, wherein, when contacting the specified member is not allowed, the server transmits, to the terminal, contact information of a contactor using a character.

9. The server according to claim 1, wherein the extractor extracts, as the instruction, a parameter indicating a member in the organization from the voice.

10. The server according to claim 1, wherein the processor processes the instruction by adding an attribute of the user to the instruction.

11. A specifying system comprising:
a terminal configured to transmit a voice being input from a user belonging to an organization; and
a server including
an extractor configured to extract an instruction, based on the voice from the terminal,
a processor configured to process the instruction, based on an attribute of the user in the organization, and
a specifier configured to specify, based on the processed instruction, at least one of a plurality of members belonging to the organization.

12. A specifying method comprising:
extracting an instruction, based on a voice being input from a user belonging to an organization;
processing the instruction, based on an attribute of the user in the organization; and
specifying, based on the processed instruction, at least one of a plurality of members belonging to the organization.

13. A storage medium storing a specifying program causing an information processing device to execute:
processing of extracting an instruction, based on a voice being input from a user belonging to an organization;
processing of processing the instruction, based on an attribute of the user in the organization; and
processing of specifying, based on the processed instruction, at least one of a plurality of members belonging to the organization.
